(19) United States
(12) Patent Application Publication
(10) Pub. No.: US 2017/0113172 A1
(43) Pub. Date: Apr. 27, 2017

(54) FUEL VAPOR ADSORPTION FILTER FOR INTERNAL COMBUSTION ENGINE AND INTAKE DUCT STRUCTURE FOR INTERNAL COMBUSTION ENGINE

(71) Applicants: TOYOTA BOSHOKU KABUSHIKI KAISHA, Aichi-ken (JP); MEIJI UNIVERSITY, Tokyo (JP)

(72) Inventors: Tomohiro YOSHIDA, Aichi-ken (JP); Tetsuya KUNO, Aichi-ken (JP); Junji HATTORI, Aichi-ken (JP); Yoshinori INUDUKA, Aichi-ken (JP); Sachiko ISHIDA, Kanagawa (JP)

(73) Assignees: TOYOTA BOSHOKU KABUSHIKI KAISHA, Aichi-ken (JP); MEIJI UNIVERSITY, Tokyo (JP)

(21) Appl. No.: 15/292,692

(22) Filed: Oct. 13, 2016

(30) Foreign Application Priority Data
Oct. 21, 2015 (JP) 2015-207365

(51) Int. Cl. B01D 53/04; F02M 35/10; F02M 35/024

(52) U.S. Cl. CPC B01D 53/04; F02M 35/02416; F02M 35/10137; B01D 2253/102; B01D 2259/4516

(57) ABSTRACT

An intake duct structure for an internal combustion engine includes an intake duct and an adsorption filter. The intake duct has an extendable-contractible portion, which is extendable and contractible in an axial direction, and the adsorption filter is arranged on the inner wall surface of the extendable-contractible portion. The adsorption filter includes an adsorption sheet. The adsorption sheet includes an adsorbent that adsorbs fuel vapor and a folding structure that is extendable and contractible in the axial direction.

### BACKGROUND OF THE INVENTION

The present invention relates to a fuel vapor adsorption filter provided in the intake passage of an internal combustion engine and an intake duct structure in which a fuel vapor adsorption filter is arranged on the inner wall surface of the intake duct.

Some internal combustion engines are equipped with a fuel vapor adsorption filter (hereinafter, referred to as an adsorption filter) provided in the intake passage. Adsorption filters are made of fiber sheets, for example, of nonwoven fabric, and support adsorbent such as activated carbon.

When an internal combustion engine is in a stopped state, fuel vapor moves upstream in the intake flow direction from the combustion chambers through the intake passage. Such fuel vapor is adsorbed by the adsorption filter. While the internal combustion engine is running, the fuel that has been adsorbed by the adsorption filter is desorbed by the intake air, and the desorbed fuel is burnt in the combustion chambers with air.

Japanese Laid-Open Patent Publication No. 2011-32992 discloses a structure in which an intake duct is connected to the downstream side in the intake flow direction of the air cleaner, and an adsorption filter is arranged on the inner circumferential surface of the intake duct. The adsorption filter is a pleated sheet, the fold lines of which extend along the axis of the intake duct.

Since the adsorption filter of the above publication is arranged such that the fold lines of the pleats extend along the axis of the intake duct, the position of the adsorption filter in the intake duct is limited to a straight section, at which the center axis is straight. Thus, if the intake duct has a short straight section, the adsorption filter cannot be installed in the intake duct.

### SUMMARY OF THE INVENTION

Accordingly, it is an objective of the present invention to provide a fuel vapor adsorption filter for an internal combustion engine that offers flexibility in selecting of the installation position.

It is another objective of the present invention to provide an intake duct structure for an internal combustion engine that allows a fuel vapor adsorption filter to be arranged on the inner wall surface of an extendable-contractible portion of an intake duct.

To achieve the foregoing objective and in accordance with one aspect of the present invention, a fuel vapor adsorption filter for an internal combustion engine including an adsorption sheet is provided. The adsorption sheet includes an adsorbent that adsorbs fuel vapor and a folding structure that is extendable and contractible in an axial direction.

The folding structure of the present invention refers to a folding structure the shape of which is reversibly changed in accordance with extension and contraction of an extendable-contractible portion of an intake duct. The folding structure includes a cylindrical structure and a polygonal tubular structure.

The folding structure of the present invention includes, but is not limited to, a bellows folding having a bellows-like folded structure, the Miura folding (refer to Japanese Laid-Open Utility Model Publication No. 56-25023), the diamond-buckling pattern folding (refer to The American Physical Society 2003, Vol. 91, No. 21 215505-1-4), the twist-buckling patterns (triangulated cylinders, twist-buckling pattern, Kresling patterns: Journal of Applied Mechanics Dec 1994, Vol. 61 773-777). If a tubular structure is employed, the folding structure preferably generates no twisting when extended or contracted in the axial direction.

The material of the adsorption sheet and the type and amount of the adsorbent, which adsorbs fuel vapor, are not particularly limited as long as the adsorption sheet, together with the adsorbent, can have a folding structure that is extendable and contractible in the axial direction. The material of the adsorbent sheet is preferably non-woven fabric or paper. The material of the adsorbent is preferably activated carbon.

To achieve the foregoing objective and in accordance with another aspect of the present invention, an intake duct structure for an internal combustion engine is provided that includes an intake duct for an internal combustion engine and the above described fuel vapor adsorption filter. The intake duct includes an extendable-contractible portion that is extendable and contractible in an axial direction. The fuel vapor adsorption filter is arranged on an inner wall surface of the extendable-contractible portion.

The intake duct having an extendable-contractible portion may be bellows-shaped. In this description, the bellows-shaped structure refers to a structure in which large diameter portions and a small diameter portions are arranged alternately in the axial direction. The cross-section perpendicular to the axis may be circular, elliptic, or polygonal. However, the cross-sectional shape perpendicular to the axis is not limited to these shapes. Also, the shape of the intake duct is not limited to the bellows-shaped structure.

### BRIEF DESCRIPTION OF THE DRAWINGS

FIG. 1 is a cross-sectional view of an intake duct and an air cleaner, illustrating an intake duct structure for an internal combustion engine according to a first embodiment.

FIG. 2A is a side view of the adsorption filter of the first embodiment.

FIG. 2B is an end view of the adsorption filter as viewed in the direction of arrow A in FIG. 2A.

FIG. 2C is a perspective view of the adsorption filter of the first embodiment.

FIG. 2D is a perspective view of the adsorption filter of the first embodiment, illustrating an axially contracted state.

FIG. 3 is a developed view of the adsorption filter of the first embodiment.

FIG. 4A is a side view of an adsorption filter of a second embodiment.

FIG. 4B is an end view of the adsorption filter of the second embodiment.

FIG. 4C is a developed view of the adsorption filter of the second embodiment.

FIG. 5 is a cross-sectional view of an intake duct of a third embodiment.

FIG. 6 is a perspective view of a spring member of the third embodiment.

FIG. 7A is a developed view of an adsorption filter of a modification.

FIG. 7B is an end view of the adsorption filter of FIG. 7A.

FIG. 8 is a cross-sectional view of an intake duct of a modification.

FIG. 9 is a cross-sectional view of an intake duct of another modification.

### DETAILED DESCRIPTION OF THE PREFERRED EMBODIMENTS

### First Embodiment

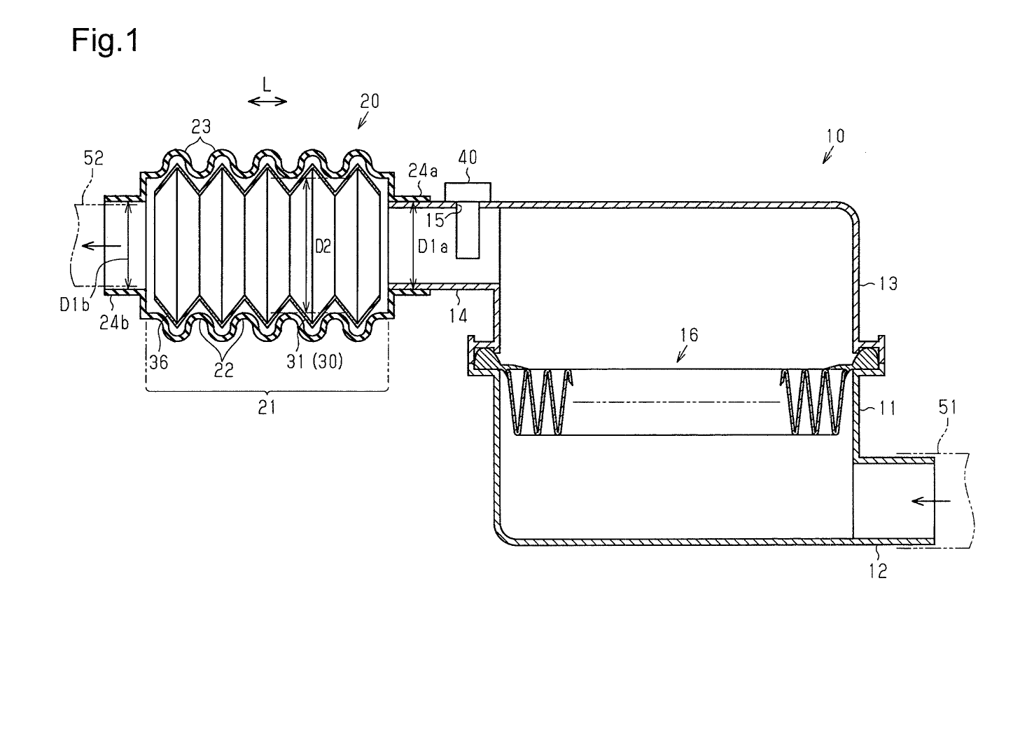

A first embodiment will now be described with reference to FIGS. 1 to 3.

As shown in FIG. 1, an air cleaner 10 is provided in the intake passage of an internal combustion engine. The air cleaner 10 includes a case 11 having an opening, a cap 13 having an opening, a filter element 16, which is arranged between the case 11 and the cap 13 to filter intake air. The case 11 has an outwardly protruding inlet 12 on the peripheral wall. An inlet duct 51 is connected to the inlet 12. The cap 13 has an outwardly protruding outlet 14 on the peripheral wall. An attaching hole 15 is formed in the peripheral wall of the outlet 14. An air flowmeter 40 for detecting the intake air amount is attached to the attaching hole 15. An intake duct 20 is connected to the outlet 14.

The intake duct 20 is made of a rubber material and includes a bellows-shaped cylindrical extendable-contractible portion 21, a cylindrical first end portion 24a, and a cylindrical second end portion 24b. The extendable-contractible portion 21 is extendable and contractible in the axial direction L. The first and second end portions 24a, 24b extend from the opposite ends of the extendable-contractible portion 21. The inner diameter D1a of the first end portion 24a and the inner diameter D1b of the second end portion 24b are set to be equal to each other. The extendable-contractible portion 21 includes a plurality of small diameter portions 22 and a plurality of large diameter portions 23, which have a larger inner diameter than that of the small diameter portions 22. Each large diameter portion 23 is located between adjacent two of the small diameter portions 22. The small diameter portions 22 have the same inner diameter. The large diameter portions 23 also have the same inner diameter. The inner diameter D2 of the small diameter portions 22 is larger than the inner diameters D1a, D1b of the first and second end portions 24a, 24b of the intake duct 20 (D2>D1a, D2>D1b). Therefore, the entire inner circumferential surface of the extendable-contractible portion 21 of the intake duct 20 is located radially outside of the inner circumferential surfaces of the first and second end portions 24a, 24b. Of the first and second end portions 24a, 24b, the second end portion 24b is located on the downstream side with respect to the intake flow direction. A throttle body 52 is connected to the second end portion 24b.

As shown in FIG. 1, an adsorption filter 30 is arranged in the extendable-contractible portion 21. The adsorption filter 30 includes an adsorption sheet 31 having adsorbent 36 that adsorbs fuel vapor. The adsorption filter 30 is arranged over the entire length in the axial direction L of the extendable-contractible portion 21. The adsorption sheet 31 has a folding structure that is extendable and contractible in the axial direction L, and is made, for example, of a single sheet of nonwoven fabric. The adsorbent 36 is preferably, for example, granular or powder activated carbon. In the present embodiment, granular activated carbon is employed as the adsorbent 36. The adsorption sheet 31 is made of nonwoven fabric, which supports the granular activated carbon (the adsorbent 36). FIG. 1 schematically shows the cross-sectional structure of the adsorption filter 30.

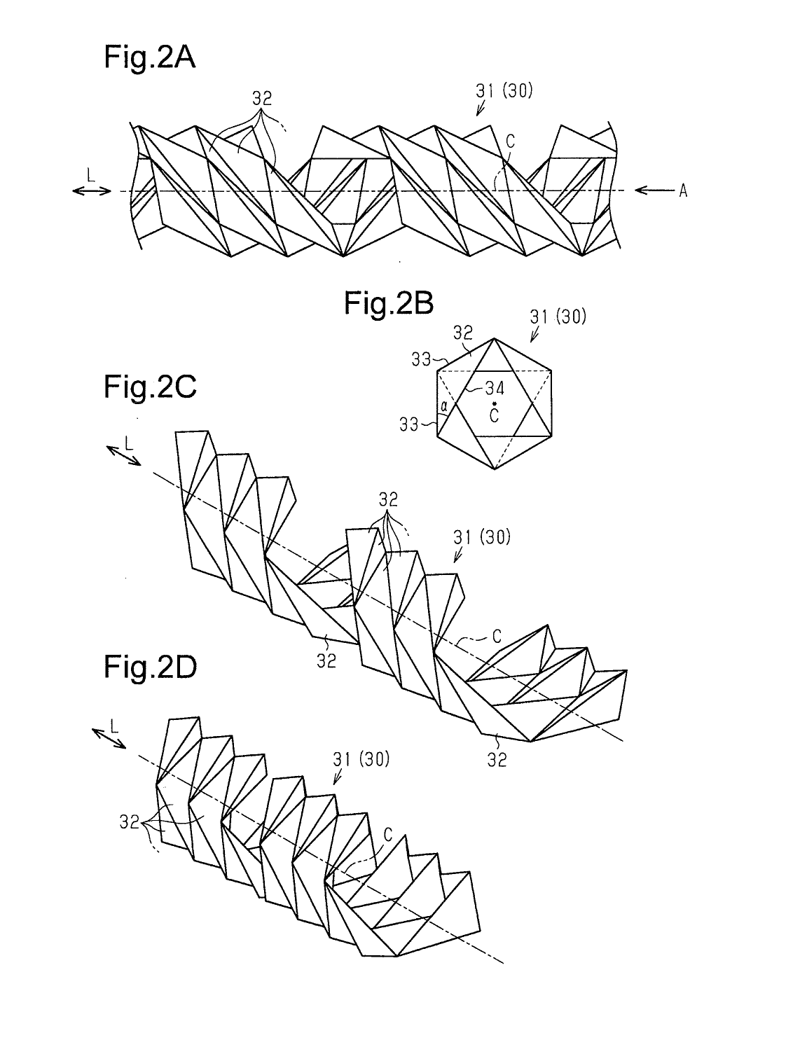

As shown in FIGS. 2A to 2D, the adsorption sheet 31 of the adsorption filter 30 has a folding structure of the above-mentioned diamond-buckling pattern folding. That is, the adsorption sheet 31 has a regular hexagonal end face and extends helically about the center axis C. The adsorption sheet 31 has multiple isosceles triangular basic patterns 32 and is structured by connecting the legs 33 of adjacent isosceles triangles together and connecting the bases 34 adjacent isosceles triangle together.

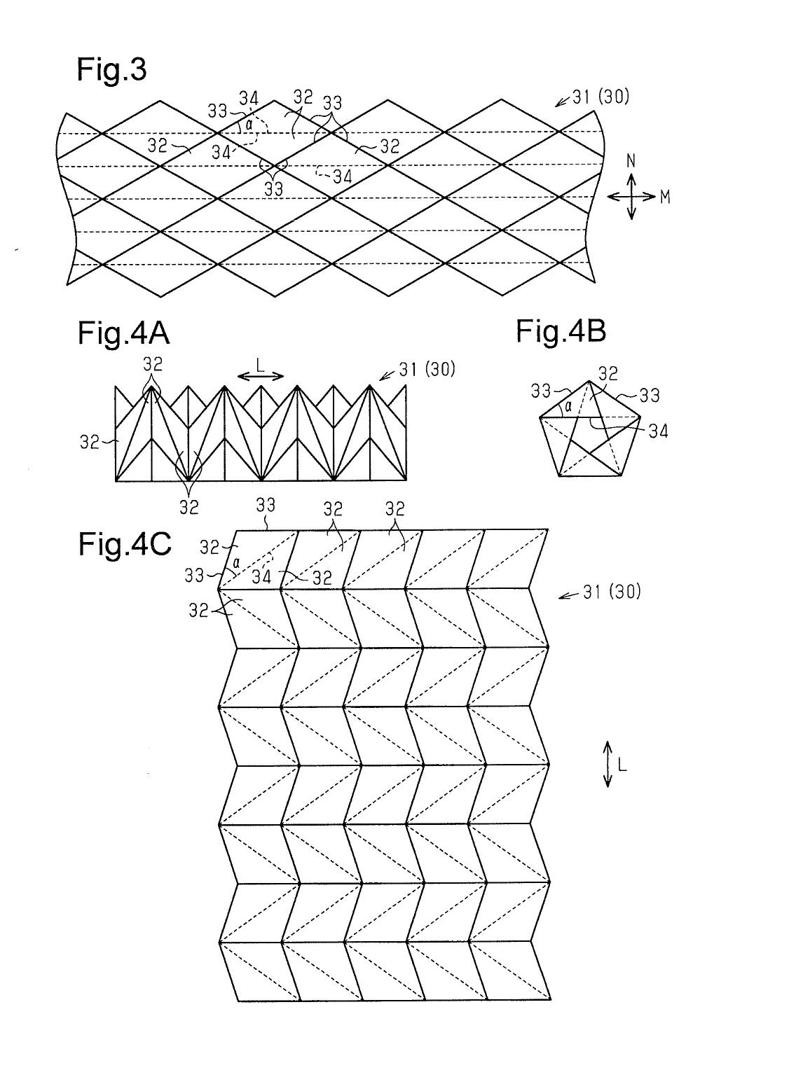

As shown in FIGS. 2B and 3, the base angle a of the basic pattern 32, that is, the angle a defined by the leg 33 and the base 34 is set to 30 degrees. As shown in FIG. 1, the entire inner circumferential surface of the adsorption filter 30 is located radially outside of the inner circumferential surfaces of the first and second end portions 24a, 24b. Also, adjacent two of the small diameter portions 22 of the extendable-contractible portion 21 sandwich part of the adsorption filter 30 in the axial direction L.

As shown in FIG. 3, in the adsorption filter 30 in a developed state, the basic patterns 32 are arranged such that the bases 34 of the basic patterns 32 extend in a predetermined direction M (the lateral direction as viewed in FIG. 3). That is, any two basic patterns 32 that are adjacent to each other in the predetermined direction M are connected to each other through the legs 33. Also, any two basic patterns 32 that are adjacent to each other in a direction N, which is perpendicular to the predetermined direction M, are connected to each other through the bases 34.

As represented by broken lines in FIG. 3, in the present embodiment, five extensions of the bases 34, which extend in the predetermined direction M, are arranged at equal intervals in the direction N, which is perpendicular to the predetermined direction M. Among the five extensions, the basic patterns 32 that include the bases 34 corresponding to the extensions at the opposite ends in the direction N are arranged such that the apexes of these basic patterns 32 project outward in the direction N. Therefore, in the adsorption filter 30 in a developed state, sections in which four basic patterns 32 are aligned in the direction N and sections in which six basic patterns 32 are aligned in the direction N are alternately arranged in the predetermined direction M.

The legs 33 of all the basic patterns 32, which are represented by solid lines in FIG. 3, are “mountain-folded,” or folded such that the created creases project toward the viewer of FIG. 3, and the bases 34 of all the basic patterns 32, which are represented by broken lines in FIG. 3, are “valley-folded,” or folded such that the created creases are recessed away from the viewer of FIG. 3. Accordingly, the adsorption filter 30 having the shape shown in FIG. 2 is obtained.

Operation of the present embodiment will now be described.

When the bellows-shaped extendable-contractible portion 21 of the intake duct 20 is extended or contracted in the axial direction L or twisted, the adsorption filter 30 changes its shape to follow the changes in the shape of the extendable-contractible portion 21 in a favorable manner. This allows the adsorption filter 30 to be arranged on the inner wall surface of the extendable-contractible portion 21 of the intake duct 20.

The above described fuel vapor adsorption filter for an internal combustion engine and the above described intake duct structure for an internal combustion engine according to the present embodiment achieve the following advantages.

(1) The adsorption filter 30 includes the adsorption sheet 31. The adsorption sheet 31 includes the adsorbent 36, which adsorbs fuel vapor, and a folding structure, which is extendable and contractible in the axial direction L.

This configuration operates in the above described manner so that the adsorption filter 30 can be arranged on the inner wall surface of the bellows-shaped intake duct 20.

This configuration also easily increases the surface area of the adsorption filter 30. This allows fuel vapor to readily contact the adsorption filter 30 and readily increases the amount of the adsorbent 36 (activated carbon). Thus, fuel vapor is effectively adsorbed.

(2) The intake duct structure for an internal combustion engine includes the intake duct 20 and the adsorption filter 30. The intake duct 20 has the bellows-shaped extendable-contractible portion 21, which is extendable and contractible in the axial direction L, and the adsorption filter 30 is arranged on the inner wall surface of the extendable-contractible portion 21.

This configuration operates in the above described manner so that the adsorption filter 30 can be arranged on the inner wall surface of the bellows-shaped extendable-contractible portion 21 of the intake duct 20. Also, the adsorption filter 30 is readily deformed to follow changes in the shape of the intake duct 20 due to extension and contraction in the axial direction L, changes in the shape of the intake duct 20 due to bending and twisting, and changes in the shape of the intake duct 20 due to combination of two or more of extension, contraction, bending, and twisting. Thus, the fuel vapor adsorption filter 30 can be arranged on the inner wall surface of the extendable-contractible portion 21 of the intake duct 20.

(3) The extendable-contractible portion 21 of the intake duct 20 has the small diameter portions 22 and the large diameter portions 23, each of which is located between adjacent two of the small diameter portions 22. The inner circumferential surfaces of the large diameter portions 23 are located radially outside of the inner circumferential surfaces of the small diameter portions 22. Adjacent two of the small diameter portions 22 sandwich part of the adsorption filter 30 in the axial direction.

With this configuration, since the small diameter portions 22 limit movement of the adsorption filter 30 in the axial direction, displacement of the adsorption filter 30 is properly restricted.

(4) The intake duct 20 has the cylindrical first and second end portions 24a, 24b, which extend from the opposite ends in the axial direction of the extendable-contractible portion 21. The entire inner circumferential surface of the extendable-contractible portion 21 is located radially outside of the inner circumferential surfaces of the first and second end portions 24a, 24b, and the entire inner circumferential surface of the adsorption filter 30 is located radially outside of the inner circumferential surfaces of the first and second end portions 24a, 24b.

With this configuration, the entire inner circumferential surface of the adsorption filter 30 does not protrude further radially inward than the inner circumferential surfaces of the first and second end portions 24a, 24b in the intake duct 20. This prevents the flow resistance of intake air from being increased by the adsorption filter 30 and thus limits increase in the pressure loss of the intake air.

(5) The intake duct 20 is located downstream of the air cleaner 10 with respect to the intake flow direction.

Fuel vapor moves toward the upstream side with respect to the intake flow direction from the combustion chambers of the internal combustion engine through the intake passage. Thus, the closer to the combustion chambers, that is, the closer to the downstream end in the intake flow direction, the higher the concentration of the fuel vapor becomes.

With this configuration, since the intake duct 20, which incorporates the adsorption filter 30, is located downstream of the air cleaner 10 with respect to the intake flow direction, a greater amount of fuel vapor can be adsorbed than in a configuration in which the intake duct 20 is located upstream of the air cleaner 10. That is, the fuel vapor adsorption performance is improved.

(6) The adsorption filter 30 is located downstream of the air flowmeter 40 with respect to the intake flow direction.

Typically, whether to install an adsorption filter in the intake passage is determined in accordance with regulations in the country or region in which the vehicle equipped with the internal combustion engine will be sold. Thus, for internal combustion engines having identical engine bodies, two different types exist: one with an adsorption filter and the other without an adsorption filter.

In the configuration in which an adsorption filter is located upstream of the air flowmeter 40 with respect to the intake flow direction, intake air flow that has been influenced by the adsorption filter flows through the air flowmeter 40. Thus, even if the intake air amount remains the same, the detection result of the air flowmeter 40 varies due to whether an adsorption filter is provided.

Conventionally, for an internal combustion engine having an adsorption filter, an engine control map different from that used for an engine without an adsorption filter is used to correct the detection result of the air flowmeter 40. Thus, two types of engine control maps need to be provided depending on whether or not an adsorption filter is provided.

In this regard, with the above described configuration, the adsorption filter 30 is located downstream of the air flowmeter 40 with respect to the intake flow direction. Thus, the detection result of the air flowmeter 40 will not be influenced by the adsorption filter 30. Thus, regardless of whether the adsorption filter 30 is provided, a common engine control map can be used.

(7) The adsorption filter 30 extends helically about the center axis C. Thus, the length of the adsorption filter 30 can be adjusted by changing the degree of extension or contraction in the axial direction L of the adsorption filter 30. The adsorption filter 30 may be formed into a complete tube. Thus, the identical adsorption filter 30 can be employed in various types of intake ducts 20 having extendable-contractible portions 21 of different lengths.

### Second Embodiment

With reference to FIGS. 4A to 4C, the differences between the second embodiment and the first embodiment will be mainly discussed.

As shown in FIGS. 4A and 4B, an adsorption sheet 31 of an adsorption filter 30 has a folding structure of the above described twist-buckling pattern. That is, the adsorption sheet 31 has a regular pentagonal end face and a tubular shape over the entire length in the axial direction L. The adsorption sheet 31 has multiple isosceles triangular basic patterns 32. The base angle a of the basic pattern 32, that is, the angle a defined by the leg 33 and the base 34 is set to 36 degrees.

As shown in FIG. 4C, in the adsorption filter 30 in a developed state, the basic patterns 32 are arranged such that one of the legs 33 of each basic pattern 32 extends in a direction perpendicular to the axial direction L (the lateral direction as viewed in FIG. 4C), and that the bases 34 of any two adjacent basic patterns 32 in the axial direction L intersect each other. Ten basic patterns 32 are aligned in the direction perpendicular to the axial direction L. The number of the basic patterns 32 in the axial direction L is adequately determined in accordance with the required length of the adsorption filter 30.

The legs 33 of all the basic patterns 32, which are represented by solid lines in FIG. 4C, are “mountain-folded,” and the bases 34 of all the basic patterns 32, which are represented by broken lines in FIG. 4C, are “valley-folded.” Accordingly, the adsorption filter 30 having the shape shown in FIGS. 4A and 4B is obtained.

The fuel vapor adsorption filter for an internal combustion engine and the intake duct structure for an internal combustion engine according to the above described second embodiment achieve advantages similar to the advantages (1) to (6) of the first embodiment.

### Third Embodiment

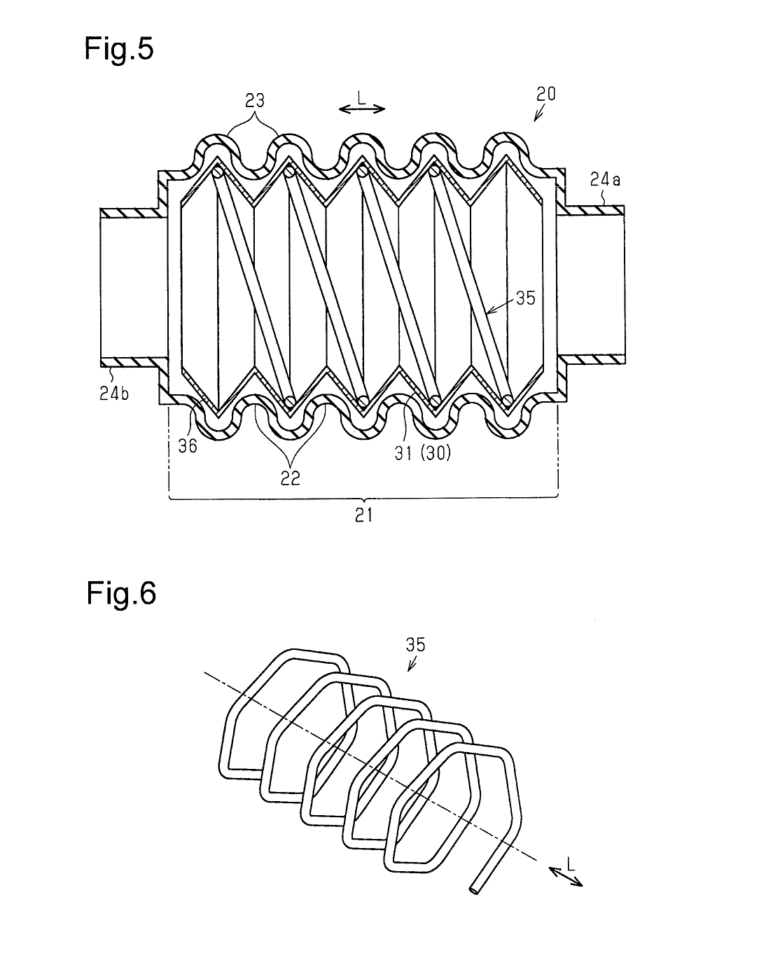

With reference to FIGS. 5 and 6, the differences between the third embodiment and the first embodiment will be mainly discussed. An adsorption sheet 31 of the third embodiment has a folding structure of the above described diamond-buckling pattern folding.

As shown in FIG. 5, a coil spring 35 is provided radially inside of the adsorption filter 30 over the entire length of the adsorption filter 30 in the axial direction L. As shown in FIG. 6, the coil spring 35 has a regular hexagonal end face. The coil spring 35 retains the adsorption filter 30 on the inner wall surface of the intake duct 20.

The fuel vapor adsorption filter for an internal Combustion engine and the intake duct structure for an internal combustion engine according to the above described third embodiment achieve the following advantage in addition to the advantages (1) to (7) of the first embodiment.

(8) The coil spring 35 is provided radially inside of the adsorption filter 30 to retain the adsorption filter 30 on the inner wall surface of the intake duct 20.

With this configuration, since the coil spring 35 retains the adsorption filter 30 on the inner wall surface of the intake duct 20, the adsorption filter 30 is restrained from being deformed or displaced by vibrations of the vehicle or pressure fluctuation of the intake air.

### Modifications

The above described embodiments may be modified as follows.

The adsorption sheet 31 may be replaced by filter paper.

Materials other than activate carbon, such as zeolite, may be employed as the adsorbent 36.

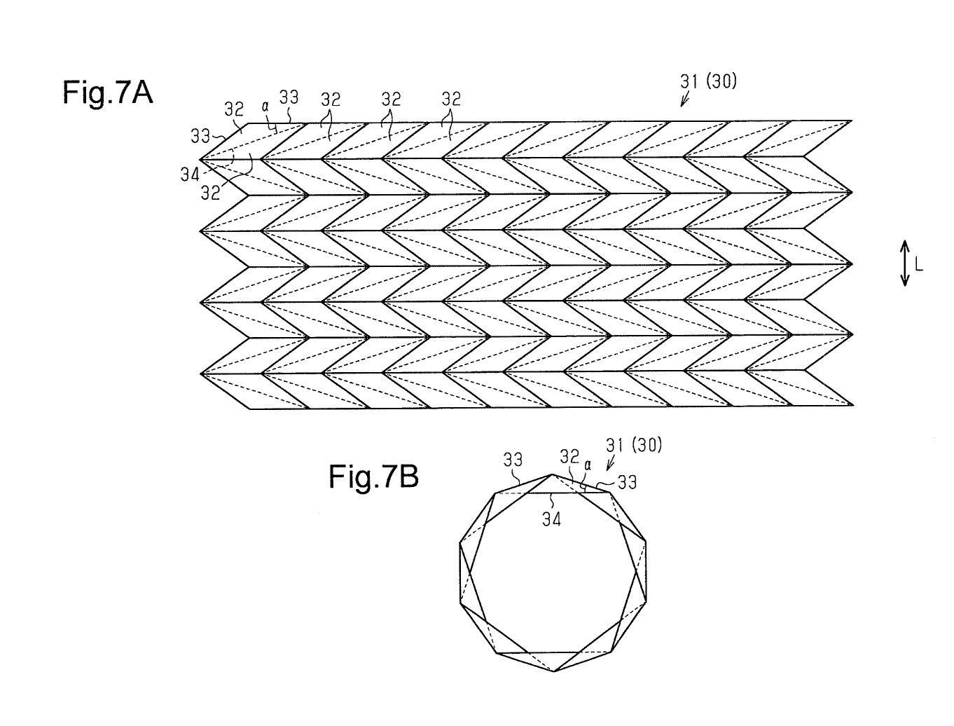

As shown in FIGS. 7A and 7B, the adsorption filter 30 may have a regular decagonal end face and a tubular shape. In this case, the base angle a of the basic pattern 32, that is, the angle a defined by the leg 33 and the base 34 is set to 18 degrees.

As shown in FIG. 7A, in the adsorption filter 30 in a developed state, the basic patterns 32 are arranged such that one of the legs 33 of each basic pattern 32 extends in a direction perpendicular to the axial direction L (the lateral direction as viewed in FIG. 7A), and that the bases 34 of any two adjacent basic patterns 32 in the axial direction L intersect each other. Also, twenty basic patterns 32 are aligned in the direction perpendicular to the axial direction L. The number of the basic patterns 32 in the axial direction L is adequately determined in accordance with the required length of the adsorption filter 30.

The legs 33 of all the basic patterns 32, which are represented by solid lines in FIG. 7A, are “mountain-folded,” and the bases 34 of all the basic patterns 32, which are represented by broken lines in FIG. 7A, are “valley-folded.” Accordingly, the adsorption filter 30 having the shape shown in FIG. 7B is obtained.

The third embodiment provides an example of the coil spring 35, which has a regular hexagonal end face. However, the shape of the coil spring 35 is not limited to this, but may be changed as necessary in accordance with the shape of the adsorption filter 30. A coil spring having a circular end face may be employed. A retaining member for retaining the adsorption filter 30 on the inner wall surface of the intake duct 20 is not limited to the coil spring 35. For example, two C-shaped ring springs may be employed to urge the opposite ends of the adsorption filter 30 radially outward.

The adsorption filter 30 may be provided partially on the extendable-contractible portion 21 with respect to the axial direction L.

In each of the above illustrated embodiments, the entire inner circumferential surface of the adsorption filter 30 is located radially outside of the inner circumferential surfaces of the first and second end portions 24a, 24b of the intake duct 20. However, the inner circumferential surface of the adsorption filter 30 may protrude further radially inward than the inner circumferential surfaces of the first and second end portions 24a, 24b.

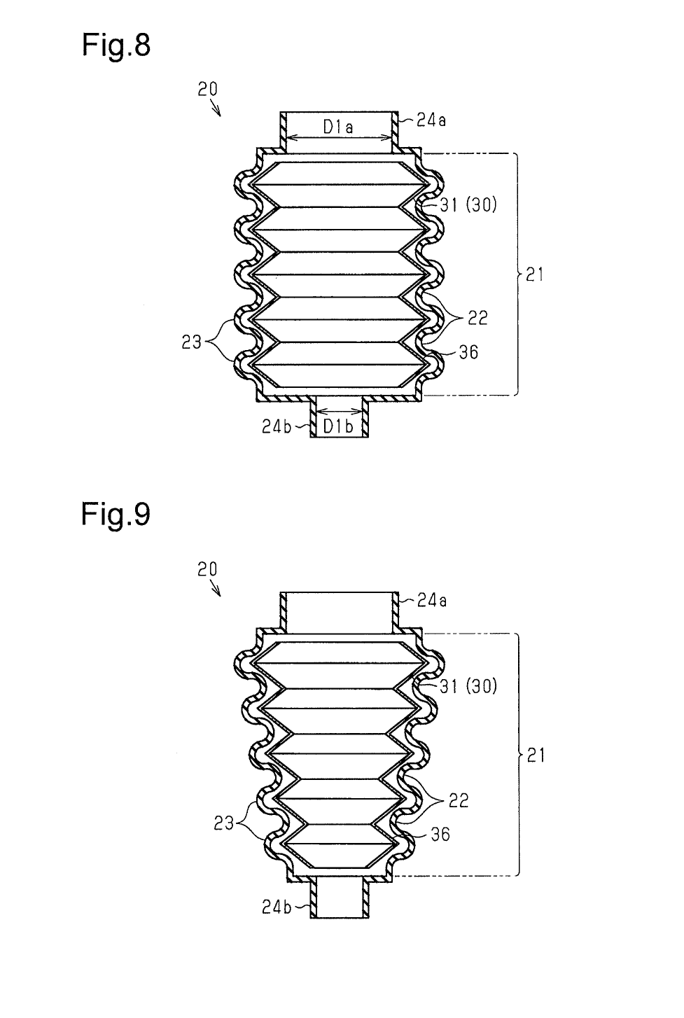

For example, as shown in FIG. 8, the inner diameters D1a, D1b of the first and second end portions 24a, 24b of the intake duct 20 may be different from each other. In this case also, the entire inner circumferential surface of the adsorption filter 30 is located radially outside of the inner circumferential surfaces of the first and second end portions 24a, 24b. Thus, the entire inner circumferential surface of the adsorption filter 30 does not protrude further radially inward than the inner circumferential surfaces of the first and second end portions 24a, 24b in the intake duct 20. This modification achieves an advantage equivalent to the advantage (4) of the first embodiment. In this case, insertion of the adsorption filter 30 is facilitated if the adsorption filter 30 is inserted into the intake duct 20 through the first end portion 24a of the larger inner diameter.

For example, as shown in FIG. 9, the intake duct 20 and the adsorption filter 30 may be tapered toward the downstream end or the upstream end with respect to the intake flow direction. In this case also, adjacent two of the small diameter portions 22 sandwich part of the adsorption filter 30 in the axial direction. This modification achieves an advantage equivalent to the advantage (3) of the first embodiment.

The position of the adsorption filter 30 is not limited to the bellows-shaped extendable-contractible portion 21. For example, the adsorption filter 30 may be arranged on the inner circumferential surface of the inlet duct 51. That is, the adsorption filter 30 can be located upstream of the air flowmeter 40 with respect to the intake flow direction. Alternatively, the adsorption filter 30 can be located upstream of the air cleaner 10 with respect to the intake flow direction.

1. A fuel vapor adsorption filter for an internal combustion engine, comprising an adsorption sheet, wherein the adsorption sheet includes an adsorbent that adsorbs fuel vapor and a folding structure that is extendable and contractible in an axial direction.

2. An intake duct structure for an internal combustion engine, comprising:
an intake duct for an internal combustion engine, wherein the intake duct includes an extendable-contractible portion that is extendable and contractible in an axial direction; and
the fuel vapor adsorption filter according to claim 1, wherein the fuel vapor adsorption filter is arranged on an inner wall surface of the extendable-contractible portion.

3. The intake duct structure for an internal combustion engine according to claim 2, wherein
the extendable-contractible portion includes
a plurality of small diameter portions, and
a plurality of large diameter portions, each of which is arranged between adjacent two of the small diameter portions,
inner circumferential surfaces of the large diameter portions are located radially outside of inner circumferential surfaces of the small diameter portions, and
part of the fuel vapor adsorption filter is sandwiched by adjacent two of the small diameter portions.

4. The intake duct structure for an internal combustion engine according to claim 3, wherein
the intake duct includes first and second cylindrical end portions, which respectively extend from opposite ends in the axial direction of the extendable-contractible portion,
an entire inner circumferential surface of the extendable-contractible portion is located radially outside of inner circumferential surfaces of the first and second end portions, and
an entire inner circumferential surface of the fuel vapor adsorption filter is located radially outside of the inner circumferential surfaces of the first and second end portions.

5. The intake duct structure for an internal combustion engine according to claim 2, wherein the intake duct is located downstream of an air cleaner with respect to an intake flow direction.

6. The intake duct structure for an internal combustion engine according to claim 5, wherein the fuel vapor adsorption filter is located downstream of an air flowmeter with respect to the intake flow direction.

7. The intake duct structure for an internal combustion engine according to claim 2, further comprising a retaining member that retains the fuel vapor adsorption filter on the inner wall surface of the intake duct.

8. The intake duct structure for an internal combustion engine according to claim 7, wherein the retaining member is a coil spring that is arranged radially inside of the fuel vapor adsorption filter.
